(19) United States
(12) Patent Application Publication
(10) Pub. No.: US 2005/0069289 A1
(43) Pub. Date: Mar. 31, 2005

(54) Transport stream recording/editing device and recording/editing method

(75) Inventor: Makoto Kusunoki, Akishima-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/947,663

(22) Filed: Sep. 23, 2004

(30) Foreign Application Priority Data
Sep. 30, 2003 (JP) 2003-339983

(51) Int. Cl. H04N 5/93; G11B 27/00

(52) U.S. Cl. 386/52; 386/55

(57) ABSTRACT

Video ES and audio ES filters extract video and audio payloads from a transport stream. Video ES and audio ES recording units record the payloads as a PES (Packetized Elementary Stream) or an ES (Elementary Stream). An editing control unit edits the ES recorded by the recording units, on the basis of an editing instruction input from a user interface. A TS generating circuit re-converts the ES edited by the editing control unit into a transport stream and outputs the transport stream.

### CROSS-REFERENCE TO RELATED APPLICATIONS

This application is based upon and claims the benefit of priority from the prior Japanese Patent Application No. 2003-339983, filed Sep. 30, 2003, the entire contents of which are incorporated herein by reference.

### BACKGROUND OF THE INVENTION

1. Field of the Invention

The present invention relates to a recording/editing device that records and/or edits data in MPEG2 transport stream format that is applied to digital broadcasting and the like.

2. Description of the Related Art

In a transport stream (hereinafter, referred to as a TS) in an MPEG2 system, video and audio compressed encoding strings are multiplexed into a packet of 188 bytes, and data are transmitted in the form of packet strings. However, video packets and audio packets that are multiplexed into a TS are not always synchronized timewise on the stream. Accordingly, it has been difficult to carry out such editing operations as designating a certain time area and deleting the range concerned. In order to solve this problem, a technology has been disclosed in Jpn. Pat. Appln. KOKAI Publication No. 2002-152738, wherein video packets and audio packets that are not synchronized timewise on the TS are rearranged timewise so as to be easily edited.

Meanwhile, in the MPEG2 system, there is a program stream (hereinafter, referred to as a PS) as a format suitable for editing, and a technology with regard to this format has been disclosed in Jpn. Pat. Appln. KOKAI Publication No. 2003-169295, wherein, when a TS is to be edited, in a state in which the TS is converted once into PS, editing is performed, and then the edited PS is converted back into the TS. However, in the prior art to synchronize video packets and audio packets on the TS timewise, it is necessary to record the TS once and thereafter synchronize video packets and audio packets. Accordingly, as areas to store a stream, an area for storing the TS and another area for storing the converted TS are necessary. Consequently, the record capacity of a recording device must be larger than the capacity of the TS to be recorded, which has been a problem with the prior art.

In the prior art wherein the TS is converted into a PS for editing and then the edited PS is converted again into a TS and output, two conversion processes are required. Consequently, devices become complicated, which has been another problem with the prior art. Further, in the case where, editing is desired again after editing is carried out once and a TS is output, it is not easy to recover a portion deleted in previous editing for re-editing.

### BRIEF SUMMARY OF THE INVENTION

In order to achieve the above problems, according to an aspect of the present invention, there is provided a transport stream recording/editing device comprising: recording units configured to extract video and audio payloads from a transport stream, and record the payloads as a PES (Packetized Elementary Stream); an editing unit configured to edit the PES recorded by the recording units, on the basis of input editing instruction information; and a converting unit configured to re-convert the PES edited by the editing unit into a transport stream and output the transport stream.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing, an example of a system to which a transport stream editing device 100 according to the present invention is applied.

FIG. 2 is a block diagram showing a configuration of an editing device 100 according to a first embodiment of the present invention.

FIG. 3 is a schematic diagram showing relations of TS, PES, and ES with video data as an example.

FIG. 4 is a flow chart showing operations of converting a TS stream as an editing objective into a PES (or ES) and recording it.

FIG. 5 is a view showing an example of data recorded in a video PES recording unit 107 and a video time information recording unit 108.

FIG. 6 is a view showing an example of data recorded in an audio PES recording unit 109 and an audio time information recording unit 110.

FIG. 7 is a flowchart showing editing operation according to the present invention.

FIG. 8 is a view showing an example of rewriting output control flags of video time information.

FIG. 9 is a view showing a reconfiguration method for TS packets in the case where a PCR is discontinuous.

FIG. 10 is a view showing an example of rewriting a PTS after editing in the case of an audio PES.

FIG. 11 is a view showing a structure of a PES header.

FIG. 12 is a block diagram showing a configuration of an editing device 100 according to a second embodiment of the present invention.

FIG. 13 is a flowchart showing recording operation according to the second embodiment.

FIG. 14 is a flowchart showing the editing operation according to the second embodiment.

### DETAILED DESCRIPTION OF THE INVENTION

(First Embodiment)

Embodiments of the present invention will be illustrated in more details by reference to the accompanying drawings.

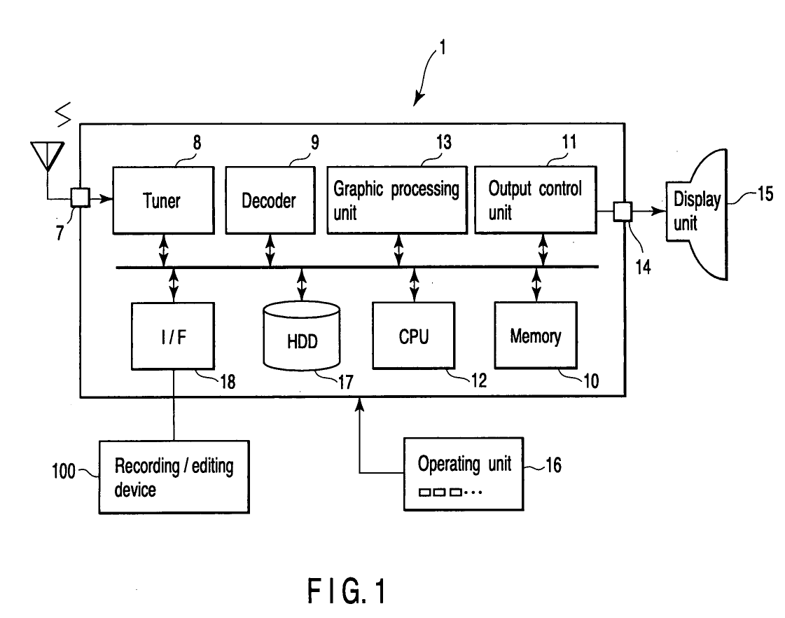

FIG. 1 is a block diagram showing an example of a system to which a transport stream editing device 100 according to the present invention is applied. The editing device 100 is connected to a TV receiver 1 via an interface (I/F) 18 such as an IEEE1394 interface.

The TV receiver 1 comprises an input unit 7, a tuner 8, a decoder 9, a memory 10, an output control unit 11, a CPU 12, a graphic processing unit 13, an output unit 14, a display unit 15, an operating unit 16, an HDD 17, and an interface 18.

To the input unit 7, broadcasting signals received by an antenna are input. From the broadcasting signals input from the input unit 7, specified program data is extracted by the tuner 8. The tuner 8 is a digital tuner that may receive digital broadcasting such as, for example, BS digital. In the embodiment, a case where digital broadcasting signals sent in TS format are received as broadcasting signals is explained. Program data extracted by the tuner 8 is decoded by the decoder 9.

The output control unit 11 processes the program data decoded by the decoder 9, displays the program on the display unit 15 via the output unit 14, and outputs audio by a speaker (not shown) therein. The graphic processing unit 13 generates display contents for displaying various setting screens and the like composed of characters and lines of the TV receiver 1 on the display unit 15. The memory 10 includes a ROM that stores various control programs and a RAM that is used as a work area of the CPU 12. The operating unit 16 is, for example, a remote controller, where various keys for various input operations are arranged.

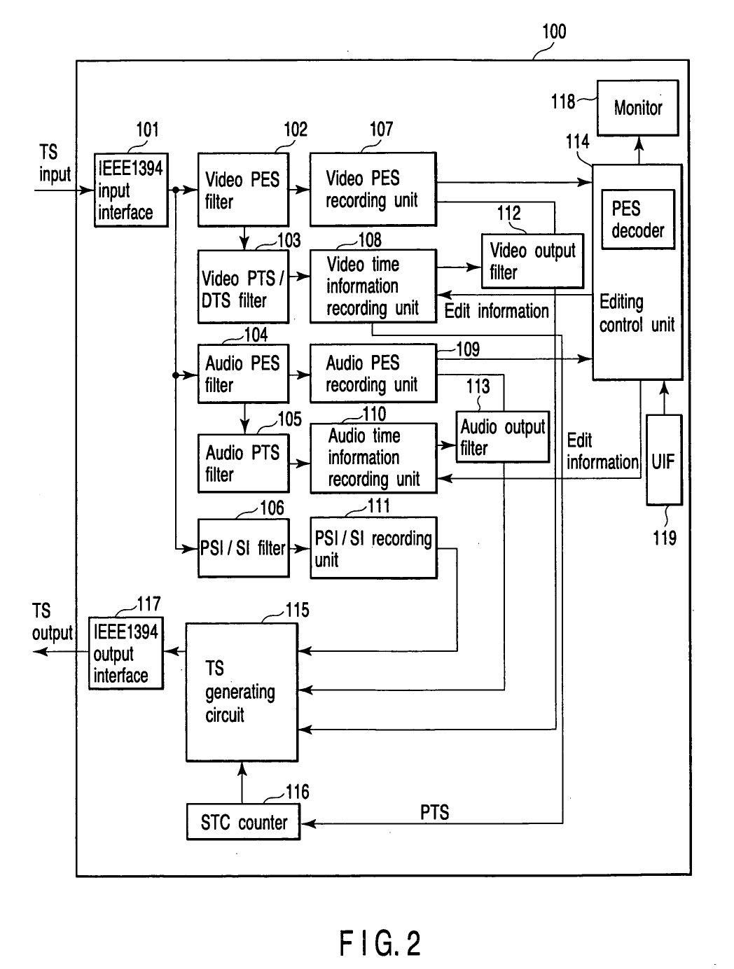

FIG. 2 is a block diagram showing a configuration of the editing device 100 according to the present embodiment. The editing device 100 edits the TS that is input from the TV receiver 1 via an IEEE1394 input interface 101, and outputs the edited TS via an IEEE1394 output interface 117 to the TV receiver 1. One of the features of this editing device 100 is that a PES or ES is filtered from the TS that is input externally, and program data is recorded in the PES or ES format.

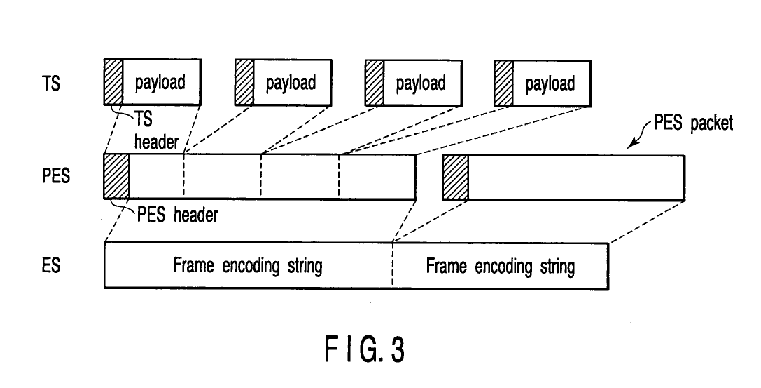

Herein, before the editing device 100 is explained, a TS, PES, and ES are explained. FIG. 3 is a schematic diagram showing relations of a TS, PES, and ES with video data as an example. An ES (Elementary Stream) is an encoding string wherein video data is compressed and encoded in unit of frame displayed on the display unit 15. A PES (Packetized Elementary Stream) is a stream wherein ES in unit of frame is divided into packets and a PES header is added to each head thereof. In the MPGE2 system standards, there is no regulation concerning the division unit in the case where an ES is made into a PES. Assuming that an ES is to be inserted into a TS, the ES is divided in unit of frame according to the broadcasting standards and made into a PES. To the PES header, PTS (Presentation Time Stamp) as time information for outputting the frame and DTS (Decoding Time Stamp) as time information for decoding the frame are added. A packet wherein a PES header is added to an ES for one frame is referred to as a PES packet.

A TS is a stream of continuous packet strings each of which consists of 188 bytes, and a PES is divided and stored in an area referred to as a payload, and to each head of the packet, a TS header is added. In the payload, various kinds of data are stored and thereby transferred, and so as to specify a data kind, a PID (Packet ID) is added to each TS header. Since a same ID is added to all the video packets that are to be transferred in TS format, for example when to obtain video data from the TS, TS packets having the PID for video packets are extracted, and only payloads thereof are jointed sequentially, thereby a PES of video is obtained. The method of extracting desired TS packets by designating a PID of TS packets in this manner is referred to as PID filtering.

Next, recording operation of the editing device 100 according to the present invention will be explained hereinafter.

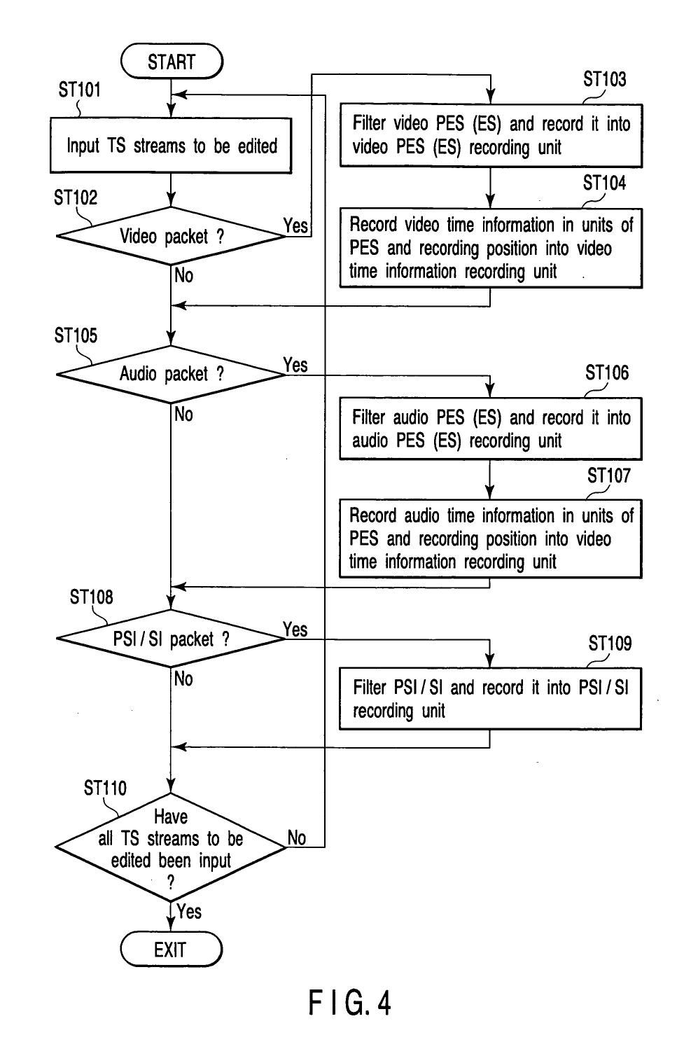

FIG. 4 is a flowchart showing operation for converting a TS stream as an editing objective into a PES or ES and recording it. Hereinafter, operation for converting a TS stream as an editing objective into a PES and recording it is explained mainly.

In the editing device 100 in FIG. 2, when a content input instruction is received via a user interface 119, a TS is input from the TV receiver 1 (ST101). This TS is the contents that are currently broadcasted, the contents being obtained from the tuner 8 of the TC receiver 1, or for example the contents that are timer recorded into the HDD 17.

The TS that is input from the TV receiver 1 is input via the IEEE1394 input interface 101 to a video PES filter 102, an audio PES filter 104 and a PSI/SI filter 106. The video PES filter 102 has a video PID filter in the inside thereof, and determines whether the input TS packet is a video packet or not (ST102). When the input TS packet is a video packet, the video PES filter extracts the video packet, and removes the TS header thereof from the video packet and pulls out the payload portion. The pulled-out payload portion is recorded into a video PES recording unit 107 (ST103).

In the case of recording the video data as a PES, the video data having a PES header added thereto is recorded into the video PES recording unit 107. Meanwhile, in the case of recording the video data as an ES, the video data is recorded into the video PES recording unit 107 without the addition of a PES header.

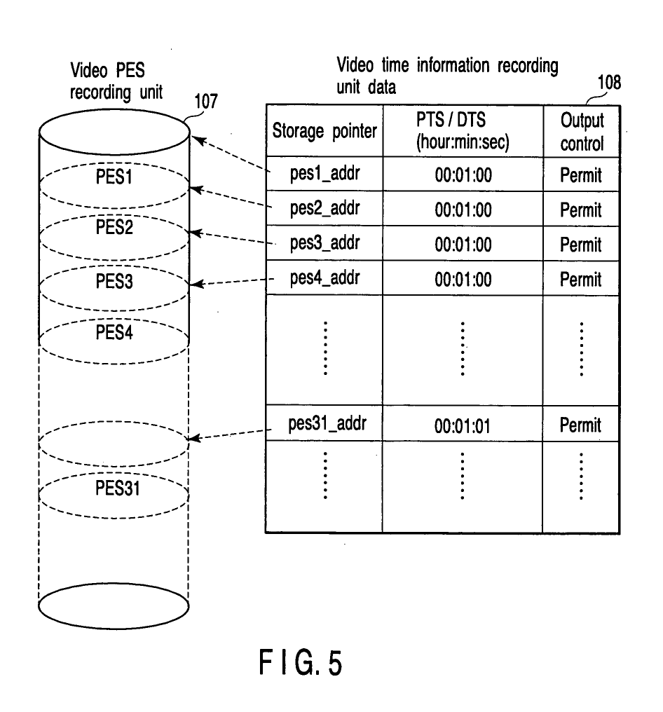

A video PTS/DTS filter 103 extracts PTS/DTS information that is added to the header portion of the video PES and records it into a video time information recording unit 108 (ST104). FIG. 5 is a view showing an example of data recorded in the video PES recording unit 107 and the video time information recording unit 108. Since the video PES is in units of frames, to the video time information recording unit 108, time information in units of frames (PTS/DTS) and a storage pointer showing the header address of the PES data recorded in the video PES recording unit are recorded. Further, all flags for output control are recorded as output permit.

The audio PES filter 104 has an audio PID filter in the inside thereof, and determines whether the input TS is an audio packet or not (ST105). When the input TS packet is an audio packet, the audio PES filter extracts the audio packet, and removes the TS header thereof from the video packet and pulls out the payload portion. The pulled-out payload portion is recorded into an audio PES recording unit 109 (ST106).

In the case of recording the audio data as a PES, the audio data having a PES header added thereto is recorded into the audio PES recording unit 109. Meanwhile, in the case of recording the audio data as an ES, the audio data is recorded into the audio PES recording unit 109 without the addition of a PES header.

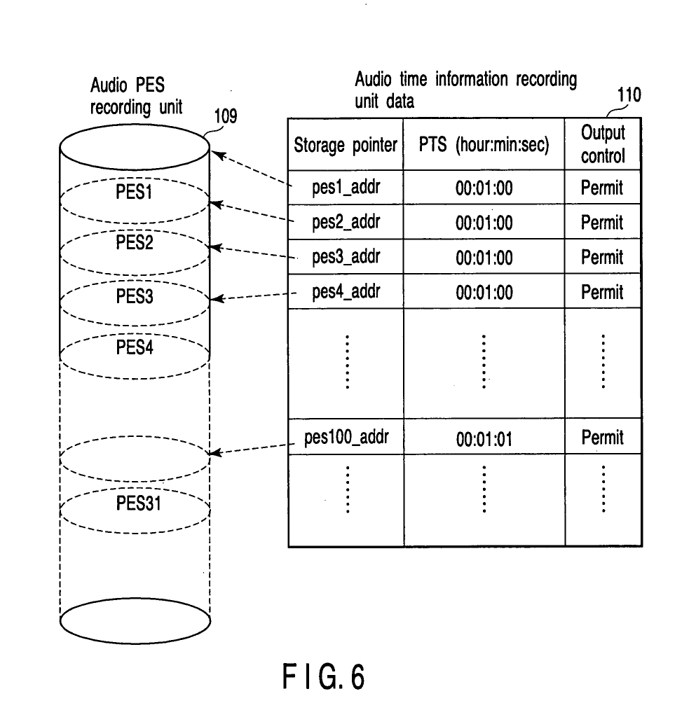

An audio PTS filter 105 extracts audio PTS information that is added to the header portion of audio PES and records the information into the audio PES recording unit 109 (ST107). FIG. 6 is a view showing an example of data recorded in the audio PES recording unit 109 and the audio time information recording unit 110. A time information PTS in units of audio frames and a storage pointer showing the header address of the PES data recorded in the audio PES recording unit 109 are recorded thereto. Further, all flags for output control are recorded as output permit.

Note that, in the case of recording video and audio data as an ES as well, video time information is recorded into the video time information recording unit 108 in the same manner as in FIG. 5, and audio time information is recorded into the audio time information recording unit 110 in the same manner as in FIG. 6.

The PSI/SI filter 106 filters PSI/SI information that is multiplexed in the TS (ST108), and records the information into a PSI/SI recording unit 111 (ST109). PSI (Program Specific Information) herein is information specific for a program, and is information necessary for a user to select a desired program, the PSI comprising 4 tables, i.e., a PAT (Program Association Table), a PMT (Program Map Table), an NIT (Network Information Table), and a CAT (Conditional Access Table). SI (Service Information) herein is program arrangement information, consisting of various information items specified for convenience of program selection. The PSI/SI filter has a PID filter in the inside thereof, and extracts necessary PSI/SI information by use of the PID filter and records the information into the PSI/SI recording unit 111. The PSI/SI information recorded in the PSI/SI recording unit is not edited normally. Therefore, the PSI/SI packet may be recorded into the PSI/SI recording unit 111 in the form of TS packets without extracting payload therefrom. Data that is recorded by the PSI/SI filter 106 includes data for data broadcasting.

Next, editing operation of the editing device 100 according to the present invention is explained hereinafter.

An editing control unit with PES decoder 114 is an editing device capable of decoding, reproducing and outputting a video PES and audio PES. Synchronous reproduction of video and audio is performed by use of video PTS/DTS information recorded in the video time information recording unit 108 and audio PTS information recorded in the audio time information recording unit 110.

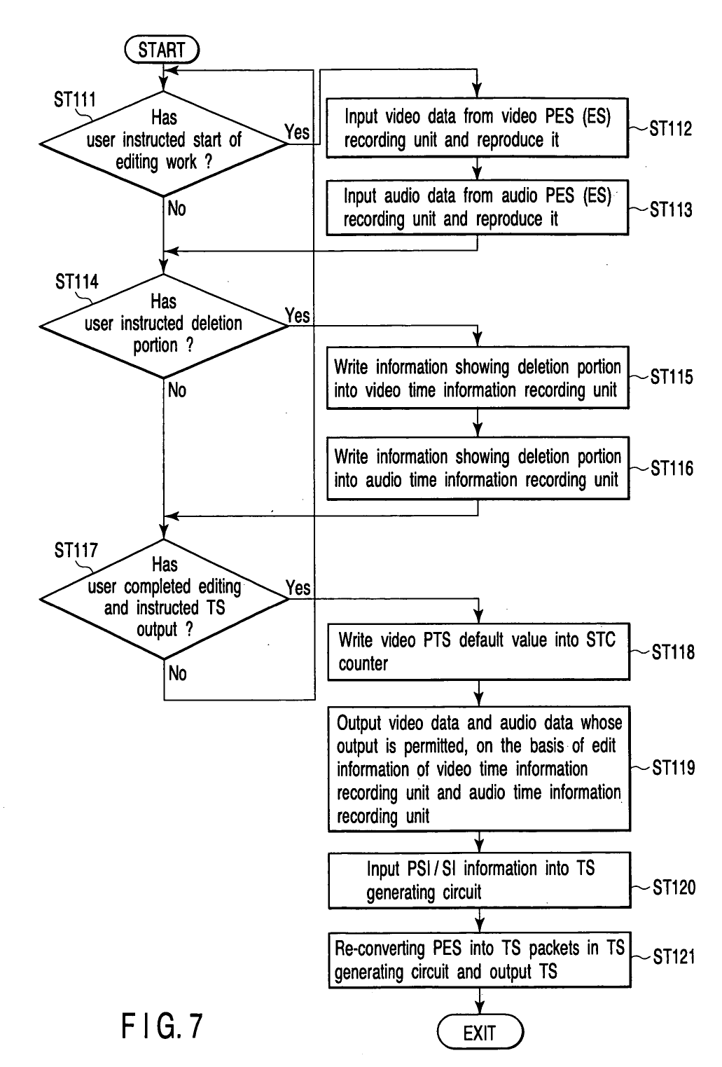

FIG. 7 is a flowchart showing editing operation according to the present invention.

When an editing work start instruction is input via the user interface 119 (ST111), the editing control unit with PES decoder 114 reproduces video and audio data from the time designated by its user. Namely, the editing control unit 114 inputs and decodes the video PES and audio PES from the video PES recording unit 107 and the audio PES recording unit 109, and reproduces them by a monitor 118 (ST112 and ST113). Thereby, video to be edited is displayed on the monitor 118, and audio is output. Note that, with regard to this replay of video and audio to be edited, video and audio signals that are output from the editing control unit 114 may be input to video and audio input terminals of the TV receiver 1, and reproduced by use of the display unit 15 or the like. In this case, the monitor 118 of the editing device 100 becomes unnecessary.

For example, in the case where a user designates reproduction from time A, the editing control unit with PES decoder 114 searches for the time A from the video PTS/DTS information of the video time information recording unit 108, acquires the PES storage pointer that corresponds to the time A, and inputs video PES data from the video PES recording unit 107. In the same manner, the editing control unit with PES decoder 114 searches for the time A from the audio PTS information of the audio time information recording unit 110, acquires the PES storage pointer that corresponds to the time A, and inputs audio PES data. Thereby, video and audio are synchronized with each other and reproduced.

The user reproduces and outputs the PES data recorded in the video PES recording unit 107 and the audio PES recording unit 109 by the monitor 118, and designates, for example, a range which the user wants to cut by use of buttons (not shown) or the like arranged on the user interface 119. Then, corresponding edit information (frame storage pointer and/or PTS) is transmitted from the editing control unit with the PES decoder 114 to the video time information recording unit 108 and the audio time information recording unit 110.

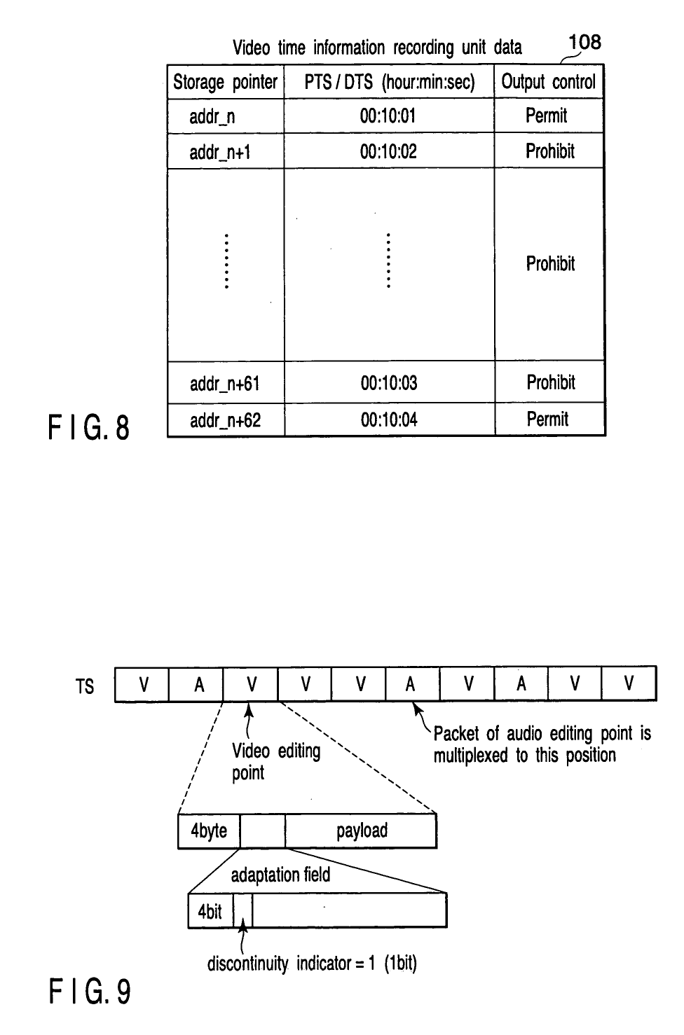

In the video time information recording unit 108 and the audio time information recording unit 110, output control flags for performing frame output control are prepared. Before performing editing, all these flags are set as output permit, and when the transmitted edit information is received, the editing control unit 114 rewrites the output control flags in the range designated for cutting (ST115 and ST116). FIG. 8 is a view showing an example of rewriting the output control flags of video time information. This example shows the case where the user has deleted frames from 00:10:02 to 00:10:03.

When the user completes all the editing operations, and instructs TS output of the edited contents, the editing control unit 114 writes a video PTS default value into an STC counter 116 via the video PES recording unit 107 (ST118).

The video PES data after editing is input into a TS generating circuit 115 via a video output filter 112. The video output filter 112 outputs only the video PES data whose output is permitted, on the basis of the output control flags recorded in the video time information recording unit 108. In the same manner, the audio PES data is input into the TS generating circuit 115 via an audio output filter 113. The audio output filter 113 outputs only the audio PES data whose output is permitted, on the basis of the output control flags recorded in the audio time information recording unit 110 (ST119).

Note that, in the case where video data is recorded in ES format, to the ES that is read from the recording unit 107, a PES header created on the basis of information such as PTS/DTS shown in FIG. 5 is added, and the data is filtered by the video output filter. With regard to audio data as well, in the same manner, in the case where audio data is recorded in ES format, a PES header is added, and the data is filtered by the audio output filter. Accordingly, video data and audio data that are supplied to the TS generating circuit 115 are same in the case where data is recorded in PES format and in the case where data is recorded in ES format.

The TS generating circuit 115 inputs PSI/SI information recorded in the PSI/SI recording unit 111 as well as the video PES data and audio PES data. The TS generating circuit 115 converts video PES data, audio PES data, and PSI/SI data in TS packets to be multiplexed, and outputs them to the outside via the IEEE1394 output interface 117 (ST120 and ST121).

In this manner, when deletion is designated in editing, the PES or ES is not directly deleted, but deletion ranges are written as output prohibit information of the PES or ES. Thereafter, at re-conversion to a transport stream, the output of the PES or ES in the deletion ranges is prohibited, thereby an effect similar to deletion of the PES or ES may be attained. Since the PES or ES is not deleted, only by rewriting the output prohibit information, editing may be redone many times.

In the case of re-conversion into TS packets, it is necessary to multiplex PCR (Program Clock Reference) to TS headers. PCR herein is information with which a value of the STC (System Time Clock) to become a time standard is set or calibrated to a value intended at the side of an encoder, in a receiving device that receives a TS and carries out MPEG decoding. This PCR is information that is arranged on a TS header at intervals of, for example, 100 ms. The STC counter 116 is a counter for generating a PCR, and is initialized as shown in ST118, on the basis of the PTS of the first video frame that can output the value of the first PCR at TS conversion. In the TS generating circuit 115, when PCR packets (TS packets having a PCR) are to be generated, the STC is acquired from the STC counter 116 and the value thereof is set as the PCR to the TS headers.

Herein, attention must be paid in multiplexing the PCR to the edited video and audio data. Video and audio data before editing are continuous timewise, and therefore the PCR may be multiplexed continuously in the same manner. However, video and audio data after editing become discontinuous between the frame at an editing point and the frame before it. Therefore, it is required to multiplex the PCR so as to become discontinuous at an editing point. Herein, the editing point is the first frame of images that are left without being cut in editing work.

At the timing when the video PES that is output from the video output filter 112 becomes the editing point, a PCR value on the basis of the PTS of the frame just after the editing point is set to the STC counter 116. Further, in the case where the PCR becomes discontinuous as above, according to the MPEG2 system regulations, discontinuity_indicator in adaptation_field must be set to 1. Therefore, at the editing point, the TS generating circuit 115 sets the discontinuity_indicator to 1. FIG. 9 is a view showing a reconfiguration method for TS packets in the case where the PCR becomes discontinuous. Since the PCR becomes discontinuous between the TS packet shown as a video editing point and the TS packet just before it, the discontinuity_indicator is set to 1. Further, in the case of multiplexing edited audio, multiplexing must be performed such that the first audio packet after the video editing point should become the packet at the audio editing point.

In the above, the case where the PCR becomes discontinuous at the editing point has been explained, while there is a method to make the PCR continuous in video and audio data after editing. To video PES headers and audio PES headers, a PTS is added so as to attain time synchronization. Before editing, the video PTS/DTS and audio PTS are continuous, while after editing, the video PTS/DTS and audio PTS become discontinuous around the editing point. Then, after editing, the PTS may be rewritten so that the video PTS/DTS and audio PTS after the editing point become continuous.

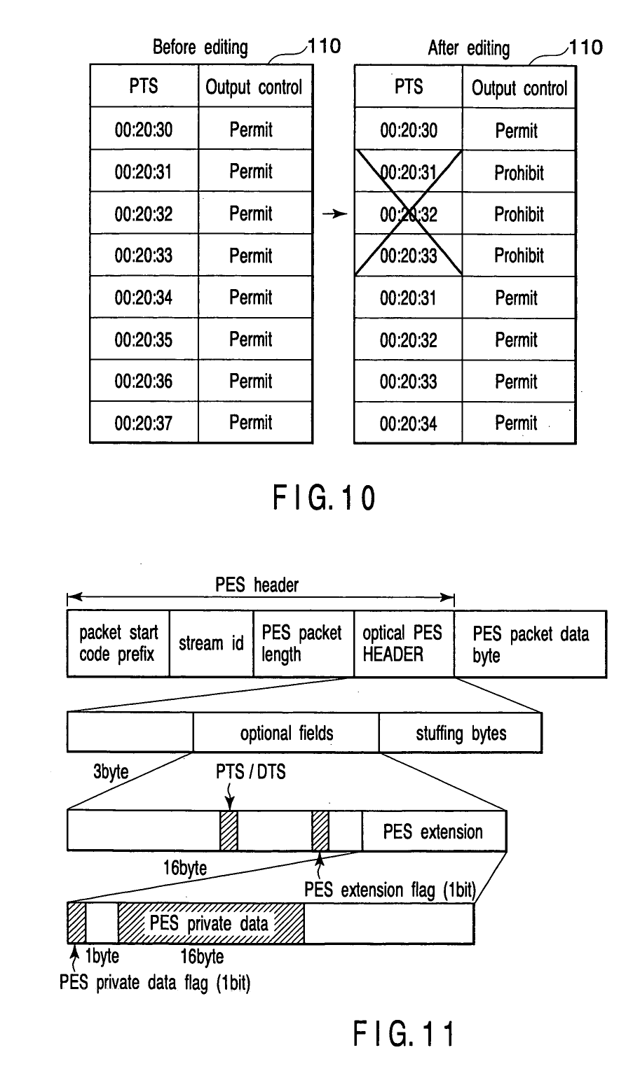

FIG. 10 is a view showing an example of rewriting the PTS after editing in the case of an audio PES. In FIG. 10, to simplify explanations, the PTS is shown not by a PTS in units of frames of the audio PES, but by a PTS in units of seconds. When audio data that was a PTS as shown in the left of the figure before editing is edited, and PES data from 00:20:31 to 00:20:33 is deleted, the PTS becomes discontinuous appearing from 00:20:30 to 00:20:34 around the editing point. Then, the PTS after the editing point for the deleted time is subtracted, and the PTS becomes continuous appearing 00:20:30 and 00:20:31 around the editing point. Although the actual PTS time precision (interval) is 90 KHz, i.e., approximately 1 second/90×10³, the principle is same as the above, and all PTS values after editing may be replaced with values that are subtracted only by time deleted in editing.

In the explanations heretofore, video and audio are recorded in PES format; meanwhile, they may be recorded in ES format and editing may be carried out. In this case, to input an ES after editing from the recording units 107 and 109 into the TS generating circuit, it is necessary to add PES headers and thereby convert the ES into PES packets.

In the present embodiment, it is assumed that the TS generating circuit is configured by hardware, while, it is possible to generate the TS by software.

According to the present embodiment, input/output data is a transport stream; meanwhile, by recording transport stream in PES or ES format at recording, it is possible to make the TS into data of an editable format. Further, redundant packets (null packets) and TS headers for rate control existing in the transport stream may be removed and thereby contents may be recorded, and as a consequence, a small recording area will do well. Furthermore, PES data is not deleted even after editing, and therefore, an advantageous effect may be obtained that it is possible for a user to repeat editing operations many times.

Moreover, according to the present embodiment, since data after editing is output in TS format, it is possible to easily record edited streams into a DVHS, or display them on a digital TV equipped with IEEE1394 terminals. Still further, in the case where data for data broadcasting is included in streams before editing, data for data broadcasting is multiplexed in the TS after editing, and therefore, it is possible to enjoy data broadcasting by edited streams.

(Second Embodiment)

Next, a second embodiment of the present invention will be explained hereinafter. The second embodiment is characterized in that the output control information (flags) recorded in the video time information recording unit 108 and the audio time information recording unit 110 in the first embodiment are added to a private data area of a PES header. FIG. 11 is a view showing a structure of a PES header. When a PES extension flag is 1, and a PES private data flag is 1, the PES private data area of 16 bytes becomes effective. By storing output control information into this private data area, it is possible to make data to be recorded into devices only PES data.

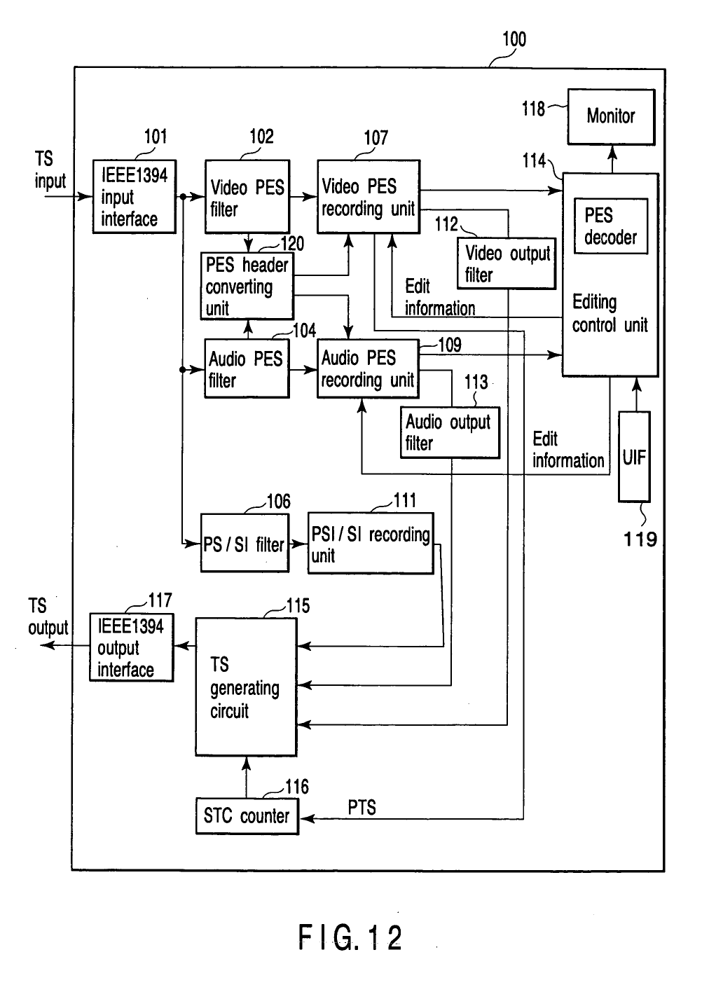

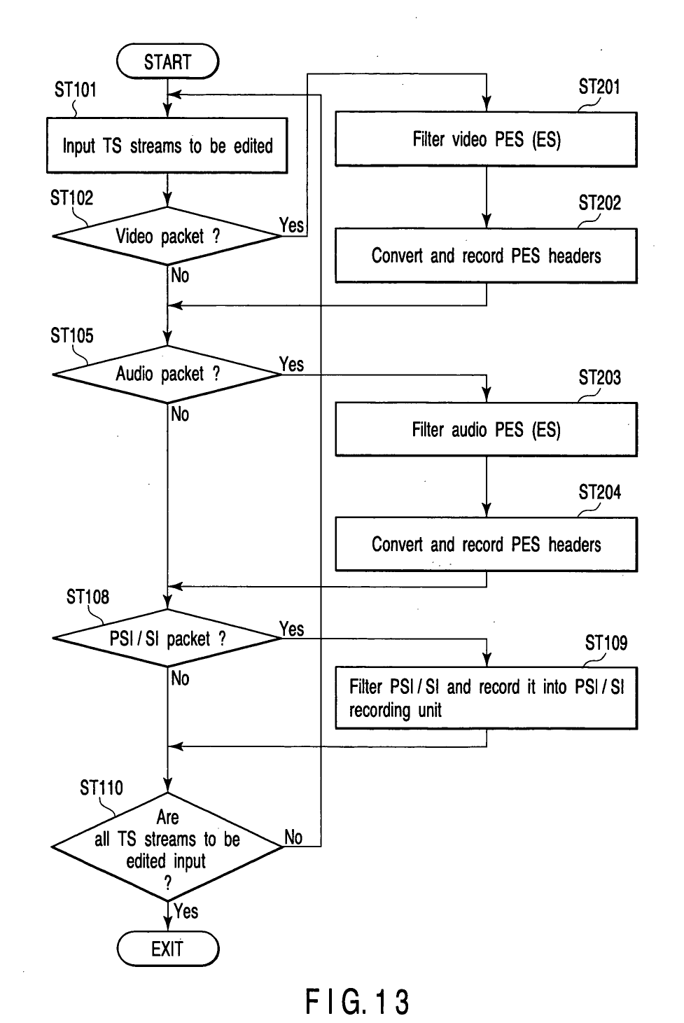

FIG. 12 is a block diagram showing a configuration of an editing device 100 according to the second embodiment, while FIG. 13 is a flowchart showing recording operation according to the second embodiment. In this flowchart, identical codes are allotted to the steps mutually corresponding to the steps in the recording actions (shown in FIG. 4) in the first embodiment.

The TS that is input from the outside is input to a video PES filter 102, an audio PES filter 104 and a PSI/SI filter 106 via an IEEE1394 input interface 101 (ST101). The video PES filter 102 has a video PID filter in the inside thereof, and determines whether the input TS packet is a video packet or not (ST102). When the input TS packet is a video packet, the video PES filter extracts the video packet, and removes the TS header thereof from the video packet and pulls out the payload portion (ST201). The pulled-out payload portion is recorded into a PES header converting unit 120. In the case when there is a PES header in the payload portion that is input to the PES header converting unit 120, the PES header converting unit 120 sets PES_extension_flag to 1, sets PES_private_data_flag to 1, and adds PES_private_data. Meanwhile, PES_private_data is initialized to 0. Data whose PES headers are converted is recorded into a video PES recording unit 107 (ST202).

The audio PES filter 104 has an audio PID filter in the inside thereof, and determines whether the input TS is an audio packet or not (ST105). When the input TS packet is an audio packet, the audio PES filter extracts the audio packet, and removes the TS header thereof from the video packet and pulls out the payload portion (ST203). The pulled-out payload portion is recorded into the PES header converting unit 120, and when there is a PES header, in the same manner as in the case of video, a private data area is added thereto and the PES header is converted. The data whose PES headers are converted is recorded into an audio PES recording unit 109 (ST204).

The PSI/SI filter 106 filters PSI/SI information that is multiplexed in the TS (ST108), and records the information into a PSI/SI recording unit 111 (ST109).

Next, a method for editing recorded video and audio data is explained hereinafter.

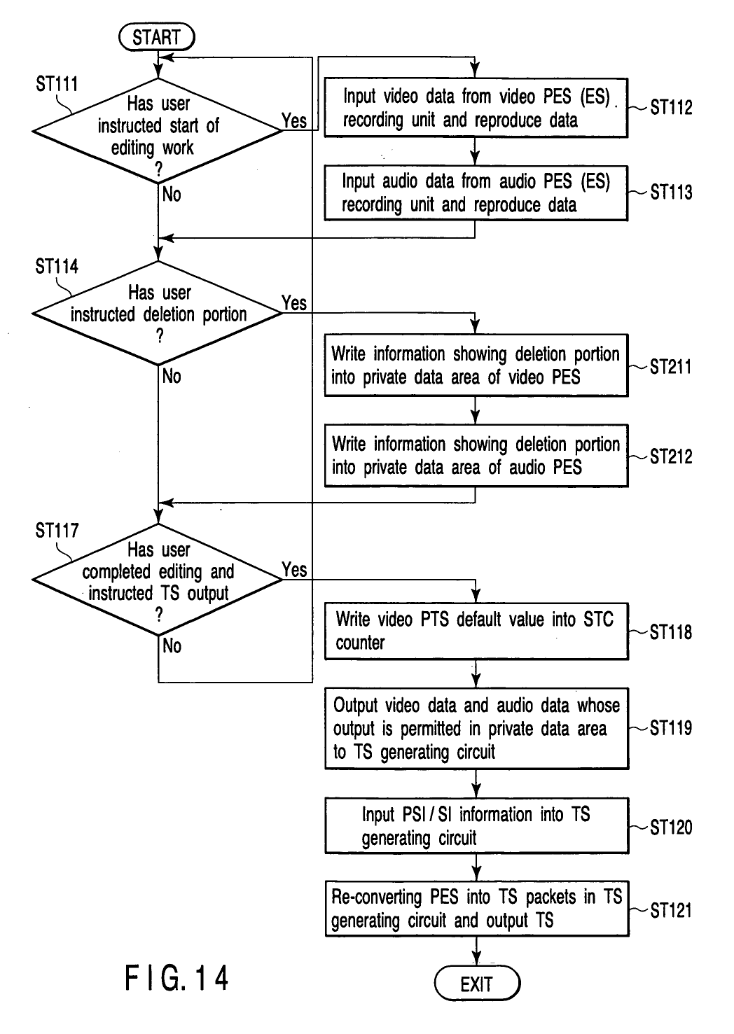

FIG. 14 is a flowchart showing editing operation according to the present embodiment. In this flowchart, identical codes are allotted to the steps mutually corresponding to the steps in the editing operation (shown in FIG. 7) in the first embodiment.

When an editing work start instruction is input via a user interface 119 (ST111), an editing control unit with PES decoder 114 reproduces video and audio data from the time designated by the user. Namely, the editing control unit 114 inputs and decodes a video PES and audio PES from the video PES recording unit 107 and the audio PES recording unit 109, and reproduces them by a monitor 118 (ST112 and ST113). Thereby, video to be edited is displayed on the monitor 118, and audio is output.

For example, in the case where a user designates reproduction from time A, the editing control unit with PES decoder 114 searches for the time A from the video PTS/DTS information written in the video PES headers in the video PES recording unit 107, and inputs data from the head of the video PES data corresponding to the time A. In the same manner, in the case of audio, the editing control unit with PES decoder 114 searches for the time A from the PTS information of the PES headers, in the audio PES recording unit 109, and inputs data from the head of the audio PES data corresponding to the time A. Thereby, video and audio are synchronized with each other and reproduced.

The user reproduces and outputs the PES data recorded in the video PES recording unit 107 and the audio PES recording unit 109, and designates, for example, a range which the user wants to cut by use of the user interface 119. Then, corresponding edit information is transmitted from the editing control unit with PES decoder 114 to the video PES recording unit 107 and the audio PES recording unit 109. The video PES recording unit 107 and the audio PES recording unit 109 convert the edit information into output control information and write in the private data area of the PES headers (ST211 and ST212). For example, in the case of a setting where when the header byte of the private area is 0, output is to be available, and when the byte is 1, output is to be prohibited, 1 is written to the header byte of the private area of the PES to be deleted.

When the user completes all the editing operations and instructs TS output, the editing control unit 114 writes a PTS default value into an STC counter via the video time information recording unit 108 (ST118).

The video PES data after editing is input into a TS generating circuit 115 via a video output filter 112. The video output filter 112 outputs the video PES data whose output is permitted, on the basis of the output prohibit information written in the private data area of the video PES headers. In the same manner, an audio output filter 113 outputs the video PES data whose output is permitted, on the basis of the output prohibit information written in the private data area of the audio PES headers (ST213). The TS generating circuit 115 converts the video PES data, audio PES data, and PSI/SI information in the TS packets to be multiplexed (ST120 and ST121). The PCR multiplexing method at TS conversion is performed in the same manner as in the first embodiment. The data converted into a TS is output to the outside via an IEEE1394 output interface 117.

In the present embodiment, output control data is added to PES headers, and accordingly, an advantageous effect may be obtained that the recording area of the editing device may be made further smaller than that in the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A transport stream recording and editing device comprising:
recording unit configured to extract video and audio payloads from a transport stream, and record the payloads as a PES (Packetized Elementary Stream);
an editing unit configured to edit the PES recorded by the recording units, on the basis of input editing instruction information; and
a converting unit configured to re-convert the PES edited by the editing unit into a transport stream and output the transport stream.

2. A transport stream recording and editing device according to claim 1, wherein
the recording unit have unit configured to record output control information relating to the recorded PES,
the editing unit sets the output control information relating to a PES in the range designated to be deleted to output prohibit, and
the converting unit has a unit configured to selectively input a PES whose output is not prohibited by the output control information, and re-converts the selectively input PES into the transport stream.

3. A transport stream recording and editing device according to claim 1, wherein
the editing unit has a unit configured to add information to prohibit output of the PES in the range designated to be deleted to a private data area of a PES header, and
the converting unit has a unit configured to selectively input a PES whose output is not prohibited by the private data area, and re-converts the selectively input PES into the transport stream.

4. A transport stream recording and editing device according to claim 1, wherein
the recording has a unit configured to separate PSI/SI information multiplexed to an input transport stream from video and audio PES and record the information, and
the converting unit, in re-converting an edited PES into a transport stream, re-multiplexes the separately recorded PSI/SI information, together with the video and audio PES, to the transport stream.

5. A transport stream recording and editing method comprising:
extracting video and audio payloads from a transport stream, and recording the payloads as a PES (Packetized Elementary Stream);
editing the recorded PES, on the basis of input editing instruction information; and
re-converting the edited PES into a transport stream and outputting the transport stream.

6. A transport stream recording and editing method according to claim 5, wherein
in the recording, output control information relating to the recorded PES is recorded,
in the editing, the output control information relating to the PES in the range designated to be deleted is set to output prohibit, and
in the converting, a PES whose output is not prohibited by the output control information is re-converted into a transport stream.

7. A transport stream recording and editing method according to claim 5, wherein
in the editing, information to prohibit output of the PES in the range designated to be deleted is added to a private data area of a PES header, and
in the converting, a PES whose output is not prohibited by the private data area is re-converted into a transport stream.

8. A transport stream recording and editing method according to claim 5, wherein
in the recording, PSI/SI information multiplexed to an input transport stream is separated from the video and audio PES and recorded, and
in re-converting, the separately recorded PSI/SI information, together with video and audio PES, is re-multiplexed to the transport stream.

9. A transport stream recording and editing device comprising:
recording unit configured to extract video and audio payloads from a transport stream, and record the payloads as an ES (Elementary Stream);
an editing unit configured to edit the ES recorded by the recording units, on the basis of input editing instruction information; and
a converting unit configured to re-convert the ES edited by the editing unit into a transport stream and output the transport stream.

10. A transport stream recording and editing device according to claim 9, wherein
the recording unit have unit configured to record output control information relating to the recorded ES,
the editing unit sets the output control information relating to the ES in the range designated to be deleted to output prohibit, and
the converting unit has a unit configured to selectively input an ES whose output is not prohibited by the output control information, and re-converts the selectively input PES into the transport stream.
